(19) United States
(12) Patent Application Publication
(10) Pub. No.: US 2003/0085268 A1
(43) Pub. Date: May 8, 2003

(54) System and method for generating a baggage tag having traveler information useful for reconciliation of mishandled baggage with the traveler

(76) Inventors: Trisha S. Kruse, Boise, ID (US); David Joe Luman, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/008,324

(22) Filed: Nov. 7, 2001

(51) Int. Cl. G06F 17/00

(52) U.S. Cl. 235/375

(57) ABSTRACT

A system and method are disclosed which enable generation of a tag that includes information useful for reconciliation of a user item with a user. Preferably, such a tag is a baggage tag that includes information useful for reconciliation of mishandled baggage with a traveler. In one embodiment, a system comprises at least one processor unit, at least one user input device, a display device, and a printer. The system further comprises software code executable to receive traveler information, including contact information for a traveler, and encode at least a portion of the traveler information into a machine-readable format. Preferably, the contact information input by a traveler and included on the generated baggage tag includes temporary contact information. Such temporary contact information may specify the time period during which it is valid for contacting the traveler.

### TECHNICAL FIELD

The present invention relates in general to generating a baggage tag having traveler information useful for reconciliation of mishandled baggage with the traveler, and more specifically to a system and method in which a kiosk terminal is provided that is operable to allow a traveler to input contact information and print a baggage tag having such information encoded thereon.

### BACKGROUND

The potential of lost baggage is a major concern of air travelers. Concern over lost baggage leads to further anxiety in air travelers, in addition to anxiety resulting from such annoyances associated with air travel as crowds, relatively cramped seating arrangements, flight delays, canceled flights, and flight security. Recent reports have noted increasing cases of “air rage” among air travelers, which can likely be attributed to the anxiety caused by such annoyances as concern over lost baggage and delayed/canceled flights. Many passengers attempt to avoid having to check baggage with an airline by increasing the amount of items included in carry-on luggage. As a result, many passengers attempt to use the maximum number of carry-on baggage having the maximum size allowed by an airline. In many cases, the carry-on baggage of passengers causes great congestion in the storage bins and passenger cabin of an airplane, and sometimes the amount of carry-on baggage exceeds the capacity available within the airplane for such carry-on baggage, which results in baggage that passenger(s) intended to carry on being stored by airline personnel in the luggage compartment of the airplane (i.e., being “checked”). Once a passenger entrusts his/her baggage to the airline, concern often arises as to whether the baggage will arrive with the passenger at the passenger's final destination.

While airlines may typically route passengers' baggage along with such passengers to their final destination, any time that an airline is entrusted with the responsibility of transporting passengers' baggage the potential exists for baggage being “mishandled.” In this sense, “mishandled” is intended to broadly encompass any situation in which a passenger's baggage is not timely received by the passenger at the passenger's destination. Baggage may not be received by a passenger at the passenger's final destination for many reasons. As examples, airline personnel may fail to load a passenger's baggage onto the flight on which the passenger is traveling, or airline personnel may fail to unload a passenger's baggage from the passenger's flight at his/her final destination. Additionally, because different baggage often looks very similar, the potential exists for a passenger to inadvertently retrieve another passenger's baggage, and such a mistake may not be discovered until much later (particularly in airports that do not require passengers to present a stub matching the baggage check tag number typically placed on checked baggage by an airline).

The U.S. Department of Transportation maintains statistics for airlines regarding the number of mishandled baggage reports filed by passengers. As an example, the U.S. Department of Transportation reports that 5.63 of every 1,000 passengers traveling U.S. airlines reported mishandled baggage for the month of December 1999. The U.S. Department of Transportation further reports that 8.07 of every 1,000 passengers traveling U.S. airlines reported mishandled baggage for the month of December 2000, indicating a rise in the number of reports of mishandled baggage over the month of December of the previous year. Lost luggage is such a concern that various industries have developed in response thereto, such as travel insurance, lost luggage sales, etc.

To aid travelers in trying to reduce the risk of lost baggage, the “globalbagtag” system has been developed in the existing art (see URL: www.globalbagtag.com). The globalbagtag system provides a website that users can access and subscribe for a two-year membership. The user is charged a fee for the membership, and then the user is mailed an acrylic tag that has printed thereon a unique serial number and instructions to log on to “www.globalbagtag.com” if the baggage to which the tag is attached is found. Considering the time delay associated with mailing the tag, the user generally receives the tag in approximately 7 working days after subscribing for membership. Once received, the user may attach the tag to his/her baggage. During the membership period, the user can access the globalbagtag website and update his/her contact information (e.g., with an itinerary for a scheduled trip, etc.). If the user's baggage is lost, upon the airport personnel finding the baggage, they can log on to globalbagtag's website and enter the serial number of the tag to obtain contact information for the owner of the baggage (according to their supplied itinerary) in order to determine how to contact the owner to notify him/her of the found baggage.

### SUMMARY OF THE INVENTION

The present invention is directed to a system and method which enable generation of a tag that includes information useful for reconciliation of a user item with a user. In a preferred embodiment, a system and method enable generation of a baggage tag that includes information useful for reconciliation of mishandled baggage with a user (e.g., traveler). According to one embodiment of the present invention, a system is disclosed that comprises at least one processor unit, at least one user input device, a display device, and a printer. The system further comprises software code executable by the processor unit to receive as input user information that includes contact information for a user. The software code is further executable to encode at least a portion of the user information into a machine-readable format, such as a bar code format. In a preferred embodiment, the system is implemented as a kiosk that may, for example, be located at a mass-transit facility, such as an airport, to enable travelers to interact with such kiosk to generate baggage tags having information that is useful for reconciliation of the travelers' baggage with the travelers in the event that such baggage is mishandled by the mass-transit facility.

In a preferred embodiment, the contact information input by a traveler (and included on the generated baggage tag) includes temporary contact information. For instance, such temporary contact information may include information identifying one or more temporary residences, such as one or more hotels, at which the traveler may be contacted. The temporary contact information may further include information specifying the time period during which such temporary contact information is valid for contacting the traveler. The traveler information input by a traveler may further include a travel itinerary for the traveler. Accordingly, in embodiments of the present invention, unlike existing systems such as the globalbagtag system described above, traveler information that is useful for reconciliation of mishandled baggage with the traveler may be included on the generated baggage tag (preferably encoded in a machine-readable format). That is, the generated baggage tag itself comprises the traveler information that is input by a traveler, and in the event that the traveler's baggage is mishandled, such traveler information may be retrieved from the baggage tag to determine the best method for timely contacting the traveler and/or forwarding the baggage to the traveler.

### BRIEF DESCRIPTION OF THE DRAWING

FIG. 1 shows an exemplary kiosk of a preferred embodiment of the present invention that is operable to receive traveler information that is useful for reconciliation of mishandled baggage with a traveler and print the information on a baggage tag;

FIGS. 2A-2B show an exemplary user interface for receiving traveler information that is useful for reconciliation of mishandled baggage with a traveler, such as contact information and/or itinerary information; and

FIG. 3 shows an exemplary system for reading traveler information that is encoded in machine-readable format on a baggage tag.

### DETAILED DESCRIPTION

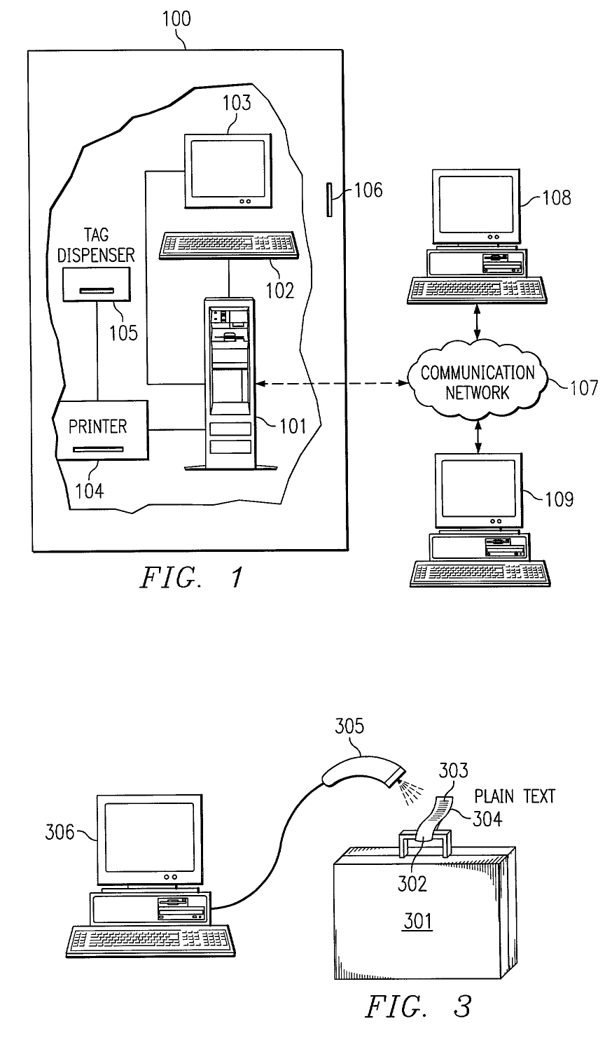

Various embodiments of the present invention are now described with reference to the above figures, wherein like reference numerals represent like parts throughout the several views. Turning to FIG. 1 an exemplary kiosk 100 is shown. According to a preferred embodiment, kiosk 100 may be implemented in a mass-transit facility, such as an airport. In alternative embodiments, such kiosk 100 may be implemented at any desired location, including as examples a travel agency, shopping mall, post office, and fun park. As described in greater detail hereafter, in embodiments of the present invention kiosk 100 is operable to receive user information that is useful for reconciliation of an item with such user and generate such information on a tag, preferably encoded in a machine-readable format (e.g., in standard bar code format). The user may then place the tag on an item (such as baggage, mail, an animal (e.g., a pet), or even a human being, such as a child, as examples). In the event that the item is not received by the user in a timely manner, the information generated on the tag may be retrieved from such tag and used in reconciliation of the item with the user.

According to a preferred embodiment of the present invention, kiosk 100 is operable to receive user information that is useful for reconciliation of mishandled baggage with the user (which may be referred to herein as a “traveler” in describing certain embodiments). In a preferred embodiment, kiosk 100 is further operable to print a baggage tag (or label) that includes such user information thereon, preferably encoded in a machine-readable format (e.g., in standard bar code format). The traveler may then place the tag on his/her baggage (which may be referred to herein as “luggage”). If the baggage is mishandled (e.g., fails to reach the possession of the traveler at his/her destination), the information may be retrieved from the baggage tag (e.g., via a standard bar code reader) by, for example, the mass-transit facility personnel handling the baggage to determine how best to contact the traveler and/or how best to direct the mishandled baggage to the traveler.

In a preferred embodiment, kiosk 100 is a stand-alone device that somewhat resembles well known automated teller machines (ATMs). As shown in FIG. 1, kiosk 100 preferably comprises processing unit 101, user input device (e.g., keyboard, mouse, trackball, touchpad, etc.) 102, and display 103. In certain implementations, display 103 may comprise well-known touch-screen technology to enable user input to be received thereby (in addition to or in place of input device 102), as well as displaying information to a user. Input device 102 and display 103 are communicatively coupled to processing unit 101 such that processing unit 101 may receive user input from input device 102 and may present output to a user via display 103. Kiosk 100 preferably further comprises printer 104 that is communicatively coupled to processing unit 101 and is operable to print traveler information on a baggage tag (as described more fully hereafter), and tag dispenser 105 that is operable to dispense the baggage tag having such traveler information thereon. Printer 104 may be any suitable printer now known or later discovered, including as examples an ink jet printer or laser printer. As described further below, the baggage tag is preferably an industrial strength tag as is commonly used by airlines for identifying a particular flight on which the baggage is to be placed and/or a particular destination for the baggage, and printer 104 is any suitable printer for printing the traveler information on such an industrial strength baggage tag. In this sense, an industrial strength tag is intended to encompass any suitable tag of any material (e.g., paper-based tag) on which printer 104 may print the traveler information, such tag being of suitable durability to withstand normal handling of the item (e.g., baggage) to which it is attached.

In certain implementations, kiosk 100 may include credit card reader 106 that is operable to receive a user's credit (or debit) card and process such card in a manner well known in the art. In this manner, such credit card reader 106 may enable a user to pay for use of the services provided by kiosk 100. Additionally, or alternatively, other payment acceptance devices may be included for receiving payment from a user, such as well known mechanisms for receiving coins and/or bills (as are commonly implemented with vending machines). As a further example, kiosk 100 may include payment acceptance devices now known or later discovered for receiving payment via a smart card presented thereto, or for receiving payment via wireless communication, such as Bluetooth or infrared communication, to enable a transfer of value for payment from a cellular telephone or personal digital assistant (PDA), as examples. Any payment acceptance mechanism now known or later discovered may be implemented at kiosk 100 to enable a user to pay for use of the services provided by such kiosk 100.

In a preferred embodiment, processing unit 101 comprises a processor, e.g., a central processing unit (CPU), that is operable to execute computer instructions. Examples of such a processor include, but are not limited to, any processor from the Itanium™ family of processors available from Hewlett-Packard Company and a PA-8500 processor also available from Hewlett-Packard Company. Processing unit 101 preferably further comprises a data storage device that is communicatively coupled thereto, which is operable for storing data, such as instructions to be executed by processing unit 101. Such data storage device may be integrated with processing unit 101 and/or arranged external to such processing unit 101. Such data storage device may include any suitable data storage device now known or later discovered, including as examples random access memory (RAM), cache memory, disk drive, floppy disk, optical disc (e.g., Compact Disc (CD) and Digital Versatile Disc (DVD)), and other data storage devices. Preferably, software code is stored to such data storage device that is executable by processing unit 101 to receive as input information useful for reconciliation of mishandled baggage with a traveler (e.g., a traveler's itinerary and contact information) and print a baggage tag including such information thereon. In a preferred embodiment, the software code is executable by processing unit 101 to generate at least a portion of such information encoded in a machine-readable format (e.g., bar code format) on the baggage tag such that it is not human readable.

In certain embodiments, processing unit 101 may be communicatively coupled to communication network 107 to enable communication with other processor-based devices, such as processor-based devices 108 and 109. Communication network 107 may be any type of communication network including, but not limited to a local area network (LAN), a wide area network (WAN), wireless network, modem to modem connection, the Internet, an Intranet, any combination of the above, or any other communications network now known or later developed within the networking arts which permits two or more computers to communicate with each other. Processor-based devices 108 and 109 may comprise any suitable devices having a processor for executing computer instructions and an interface for coupling to communication network 107. Examples of such devices 108 and 109 include other kiosks (such as Kiosk 100), personal computers (PCs), laptop computers, personal digital assistants (PDAs), and cellular telephones.

In operation of a preferred embodiment, kiosk 100 may be implemented at a mass-transit facility, such as an airport, train station, bus station, ship dock, or any other type of mass-transit facility that handles travelers' baggage. A traveler may, before relinquishing his/her baggage to the baggage handling personnel of the mass-transit facility (e.g., baggage handling personnel of an airline), interact with kiosk 100 to obtain a baggage tag that includes traveler information useful for reconciliation of the baggage with the traveler in the event that it is mishandled by the mass-transit facility. Such traveler information may include, for example, the traveler's itinerary and contact information. Preferably, at least a portion of the traveler information is encoded in a machine-readable format on the baggage tag. It may be desirable, for instance, to have at least a portion of the traveler information (such as the traveler's contact information and/or travel itinerary) encoded in a machine-readable format so that the information is not readily readable by persons that may casually observe the traveler's baggage tag. For example, at least a portion of the traveler information may be encoded into Symbol Technologies public domain format PDF417 two-dimensional bar code. Such a bar code may be generated using Symbol Technologies' publicly available software. Of course, the information may be encoded into a machine-readable format other than a two-dimensional bar code. In various implementations of a preferred embodiment, at least a portion of the traveler information may be encoded into any machine-readable format now known or later discovered.

The traveler then attaches the baggage tag onto his/her baggage, and relinquishes the baggage for handling by the mass-transit facility (e.g., checks the baggage to a particular airline). The baggage tag may be attached to the baggage in any suitable manner. For instance, in certain implementations the baggage tag may include adhesive such that the tag may be looped through the handle of the baggage and adhered to itself. As a further example, in other implementations the baggage tag may be placed in a pocket of the baggage that has a clear window such that the baggage tag is visible. In the event that the traveler's baggage is mishandled, the traveler information on the baggage tag may provide assistance in timely contacting and/or forwarding the baggage to the traveler. For instance, personnel of the mass-transit facility may locate the baggage but may be uncertain as to whom the baggage belongs and/or how to contact the owner. The traveler information on the baggage tag may assist such personnel in determining the owner of the baggage, as well as information for timely contacting and/or forwarding the baggage to such owner. Any portion of the baggage tag that is encoded in machine-readable format may be read by an appropriate reader device, such as a bar code scanner, to ascertain such traveler information. As an example, the baggage tag may include a cellular telephone number for the traveler that may enable the mass-transit personnel to contact the traveler to timely notify the traveler of the found baggage. As another example, the baggage tag may include an itinerary for the traveler, which may include temporary contact information such as a hotel at which the traveler is to be a guest for a particular time period, which may be useful in contacting the traveler and/or forwarding the baggage to the traveler (e.g., at his hotel).

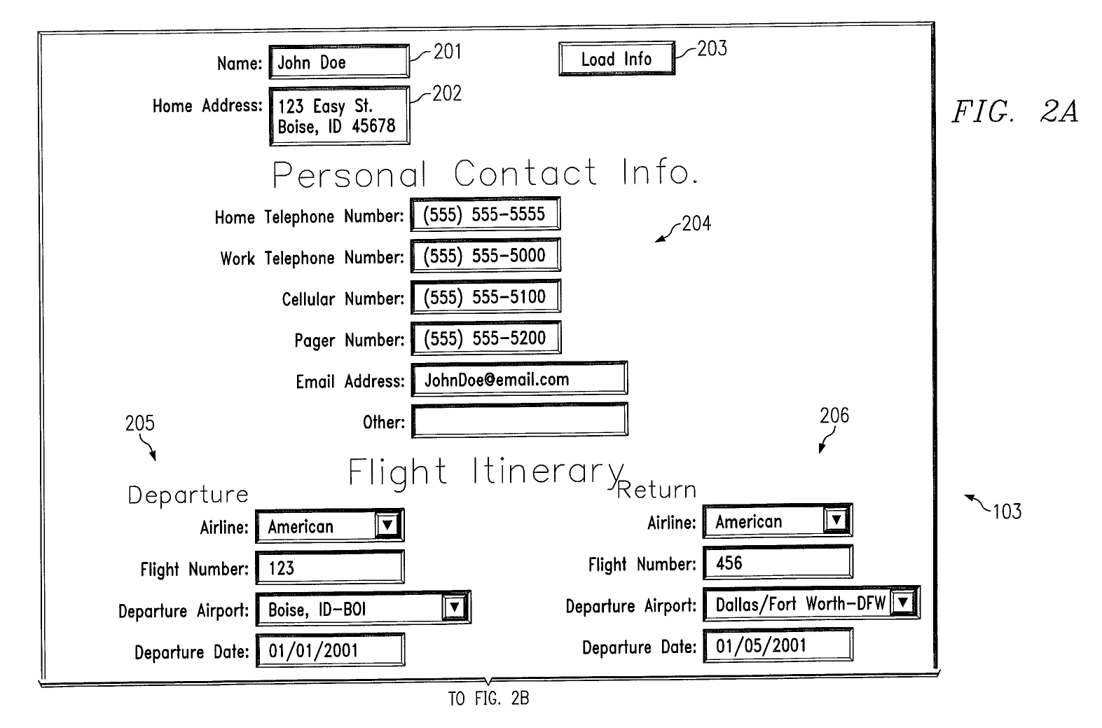

Turning to FIGS. 2A and 2B, an exemplary user interface for receiving traveler information that is useful for reconciliation of mishandled baggage with a traveler is shown.

Such traveler information may include, for example, contact information and/or itinerary information supplied by a traveler that may be of assistance in the event the baggage is mishandled to enable the traveler to be contacted and/or the baggage to be forwarded to the traveler in a timely fashion. For instance, as shown in FIGS. 2A-2B, the user interface may prompt a traveler to input his/her name at input box 201, home address at input box 202, personal contact information at input box(es) 204, flight itinerary at input boxes 205-206, and temporary contact information at input box(es) 209. As described further below, such traveler information may be received via the user interface and then printed onto a baggage tag. Preferably, at least a portion of such traveler information is encoded into a machine-readable format and printed onto the baggage tag.

Software code may be executing on processing unit 101 (of FIG. 1), for example, to generate the exemplary user interface of FIGS. 2A-2B on display 103 of kiosk 100. In this example, input boxes 201 and 202 are provided to receive a traveler's name and home address, respectively. The traveler's home address may be useful, for example, to provide an address to which mishandled baggage may be forwarded if no other contact or forwarding information is appropriate. For instance, the baggage may be forwarded to the traveler's home address if the temporary contact information (described below) has expired. Additionally, input boxes 204 are provided to receive a traveler's personal contact information. Such personal contact information may include such information as the traveler's home telephone number, work telephone number, cellular telephone number, pager number, email address, and/or other contact information for the traveler (such as a personal fax number for the traveler). Such personal contact information may be useful, for example, to provide one or more methods of contacting the traveler. With the increasing popularity of mobile devices, such as cellular telephones, travelers are often accessible even when traveling, which may aid in timely contacting a traveler regarding mishandled baggage. For instance, by including the traveler's cellular telephone number in the information printed on the baggage tag, the traveler may be contacted even while away from his/her home (when the traveler may not be reached via his/her home telephone number).

Travel itinerary information may also be received via the user interface. For instance, a traveler's flight itinerary may be received by the interface. In the example of FIGS. 2A and 2B, input boxes 205 and 206 are provided for receiving departure flight information and return flight information, respectively. Thus, the traveler may input such information as the airline on which he/she is traveling, the flight number, departure airport, departure date, scheduled departure time, final destination airport, arrival date, and scheduled arrival time for both departing and returning flights (of a round-trip). If the traveler is to have any connecting flights in either the departing trip or the returning trip, the traveler may activate button 207 and/or button 208 (e.g., by clicking on such button with a pointing device) to be presented an interface for inputting information regarding such connecting flights. In the exemplary itinerary provided in FIGS. 2A-2B, a traveler is departing from Boise, Id. on Jan. 1, 2001 at 8:00 a.m. on American Airlines flight number 123, which is scheduled to arrive at Dallas-Fort Worth international airport on Jan. 1, 2001 at 11:30 a.m. On the return trip, the traveler is departing from Dallas-Fort Worth international airport on Jan. 5, 2001 at 9:30 a.m. on American Airlines flight number 456, which is scheduled to arrive at Boise, Id. on Jan. 5, 2001 at 1:00 p.m.

Temporary contact information may be input by the traveler in input boxes 209. For instance, the traveler may input a hotel or residence of a relative or friend at which the traveler will be temporarily residing (while away from home). The traveler may further specify the time period at which the traveler may be contacted at such temporary residence. For instance, in the example of FIG. 2B, the traveler has input that he/she may be contacted at the Holiday Inn in Dallas. As shown in this example, the user may provide the address of such temporary residence, as well as its telephone number. The traveler has further input that he/she may be contacted at the Holiday Inn from Jan. 1, 2001 through Jan. 4, 2001.

Often, a traveler may intend to temporarily reside at various different locations, in which case the traveler may activate button 211 to be presented an interface for specifying further temporary contact locations with corresponding time periods during which the traveler may be contacted at each location.

In accordance with certain embodiments of the present invention, search button 210 may be provided that, when activated, enables a user to search through a list of previous temporary information that he/she has provided to the system (e.g., for previous trips). That is, information previously entered by the traveler (e.g., to kiosk 100 or other such kiosks that are communicatively coupled to a data storage device) may be stored for the traveler and associated with the traveler's name, with an identification code assigned to the traveler (which the traveler may enter upon each use), or otherwise associated with the traveler. Thus, for example, if the traveler frequently travels to a particular temporary location (e.g., a particular hotel), such information may be available for selection by the traveler, thereby alleviating the user of having to re-enter such temporary contact information. Additionally, or alternatively, kiosk 100 may be communicatively coupled to a data storage device that has stored thereto listings of temporary residences (e.g., hotels) available in various areas, and the traveler may search through a list of temporary residences available in the surrounding area of the traveler's destination from which the traveler may select one or more of such temporary residences to be included in the traveler's temporary contact information.

In the event of mishandled baggage, such temporary contact information may be useful in timely contacting the traveler and/or forwarding the traveler's baggage to him/her. For instance, considering the temporary contact information input in the example of FIG. 2B, if the traveler's baggage is mishandled, such temporary contact information may be retrieved from the traveler's baggage tag to determine that the traveler may be contacted at the Holiday Inn from Jan. 1, 2001 until Jan. 4, 2001 and/or the traveler's baggage may be forwarded to the Holiday Inn during such temporary time period. Without the baggage tag of embodiments of the present invention including such information, the airline personnel would likely not have such temporary contact information for the traveler. For instance, the airline may, at most, have the traveler's home address. Thus, the baggage tag may enable the traveler to be contacted and/or the traveler's baggage to be forwarded to him/her in a more timely fashion than may be possible without the baggage tag. For example, the baggage tag of embodiments of the present invention may enable the traveler's mishandled baggage to be forwarded to him/her while away from home at a temporary location, rather than receiving such mishandled baggage only after returning home.

As further shown in the example of FIG. 2A, the user interface may include a “load information” button 203, which when activated may retrieve information previously stored to a database for the traveler. For instance, upon inputting contact information to kiosk 100 in a first session, the traveler's contact information may be stored to a database as a profile. Thereafter, in a subsequent session in which the traveler is accessing kiosk 100 (or another like kiosk that is communicatively coupled to kiosk 100), the traveler may input identification (e.g., his/her name and/or password) and activate button 203 to load the traveler's stored profile (e.g., contact information). Thus, for instance, the traveler's pre-stored contact information may be loaded into personal contact input boxes 204 to enable the traveler to review and/or modify such contact information.

As another example, in certain embodiments, kiosk 100 may be communicatively coupled to processor-based devices, such as devices 108 and 109, via communication network 107, and a traveler may input traveler information via such a processor-based device that is communicatively coupled to kiosk 100. For instance, communication network 107 may comprise the Internet, and the exemplary user interface of FIGS. 2A-2B may be presented via the Internet to processor-based device 108 for receiving the traveler's information. The traveler may, therefore, input the traveler information before arriving at kiosk 100 (e.g., before arriving at the mass-transit facility at which kiosk 100 is implemented). The input traveler information may be stored to a data storage device that is communicatively coupled to kiosk 100. Upon arriving at kiosk 100, the traveler may activate load information button 203 to load the traveler information previously input by the traveler via processor-based device 108, and such traveler information may be retrieved by kiosk 100 from the data storage device to populate the corresponding input boxes of the user interface. In this manner, by pre-storing traveler information before arriving at kiosk 100, the amount of time required for interacting with kiosk 100 at the mass-transit facility to obtain a baggage tag may be reduced.

The exemplary user interface of FIG. 2B includes clear button 212, print button 213, save button 214, and exit button 215. A traveler using kiosk 100 may activate clear button 212 to clear all of the input fields of the user interface. Once the traveler has completed the appropriate input fields of the user interface, he/she may activate print button 213, which causes the software code to execute to print (e.g., via printer 104) a baggage tag that includes at least a portion of the input traveler information thereon. More specifically, processor unit 101 communicates the appropriate print command to printer 104 to generate a baggage tag having traveler information printed thereon, and such printed baggage tag may be dispensed to the traveler via tag dispenser 105. Preferably, the software code encodes at least a portion of the input traveler information into a machine-readable format, and prints such encoded traveler information on the baggage tag in the machine-readable format. For example, in one embodiment, at least the traveler's contact information (e.g., the personal contact information of input boxes 204 and/or the temporary contact information of input boxes 209) are encoded into a machine-readable format for printing in such machine-readable format onto the baggage tag. In this manner, the privacy of the traveler's contact information may be maintained as to casual human observers.

A traveler using kiosk 100 may activate save button 214 to save the input information to a data storage device for later retrieval. For example, the user's contact information may be saved to a database as a profile for use in later sessions. As another example, a user may save traveler information that is input via a remote processor-based device 108 for retrieval upon accessing kiosk 100. Once the session is complete (e.g., the traveler has printed the needed baggage tag(s)), the traveler may activate exit button 215 to end the session, which may clear the traveler's information from the user interface and re-set the user interface for receiving traveler information from another user.

Once the baggage tag that includes traveler information printed thereon is received from kiosk 100, the traveler may couple the tag to a piece of the traveler's baggage. Preferably, the baggage tag is a paper-based, industrial-strength tag such as is commonly utilized by airlines for labeling baggage, and such baggage tag may include adhesive on opposing ends to enable it to be adhered to itself That is, in one implementation the baggage tag may be looped through the handle of a piece of baggage, for example, and then adhered to itself to secure the baggage tag to the piece of baggage. In the event that the baggage is mishandled, the traveler information from the baggage tag may be retrieved and used for reconciliation of the baggage with the traveler. More specifically, the baggage tag may aid in contacting the traveler and/or forwarding the mishandled baggage to the traveler in accordance with the traveler information included on the baggage tag.

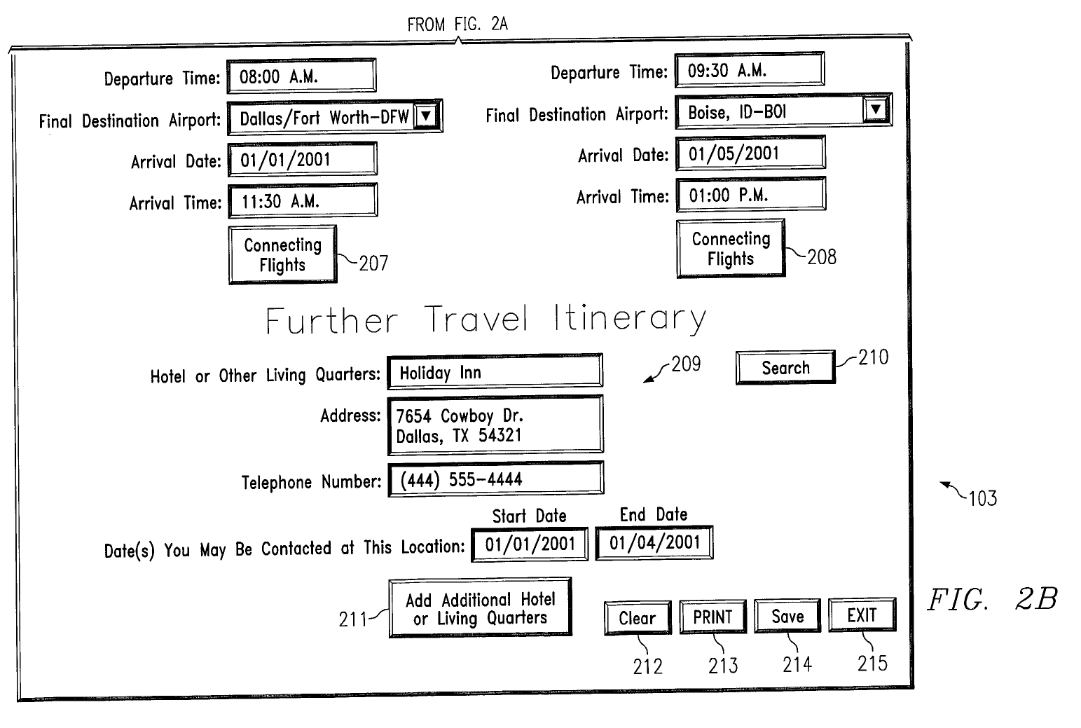

FIG. 3 shows an exemplary system for reading traveler information that is encoded in machine-readable format on a baggage tag. For instance, baggage tag 302 is generated by kiosk 100 and may include traveler information that is encoded in a machine-readable format 303 and may also include plain text 304 that is in human-readable format. Baggage tag 302 is removably coupled to the traveler's piece of baggage 301. As an example, in one implementation, plain text 304 may include instructional text that instructs if this piece of baggage 301 is found, information as to how best to contact its owner may be retrieved from the encoded machine-readable format with an appropriate device (such as standard bar code scanner 305, as described further below). All, or at least relatively sensitive portions, of the traveler's information may be encoded into a machine-readable format 303, such as a standard PDF417 two-dimensional bar code, on baggage tag 302. For instance, at least the traveler's contact information may be printed on baggage tag 302 in machine-readable format 303. In certain implementations, portions of the traveler information, such as the traveler's name and/or the traveler's flight information, may be included on baggage tag 302 in human readable format 304; although in other implementations such information may instead be included on baggage tag 302 in machine-readable format 303.

In the event that baggage 301 is mishandled (such that it is not received by the traveler at the traveler's destination), the traveler information on baggage tag 302 may be used for reconciliation of baggage 301 with the traveler. For instance, a reader device, such as bar code scanner 305, may be used to retrieve the traveler information that is encoded on baggage tag 302 in machine-readable format 303. A processor-based device 306 may be communicatively coupled to such reader device 305 to process the information read from baggage tag 302 by reader device 305 to present the traveler information to a user. Thus, for instance, a bar code scanner 305 may be used to read traveler contact information encoded in machine-readable format 303 on baggage tag 302 and processor-based device 306 may present such traveler information to a user in human-readable format (e.g., in plain text). Once ascertained from baggage tag 302, the traveler's contact information may be used to contact the traveler and/or forward baggage 301 to the traveler in a timely manner.

In certain embodiments, the traveler information may not only be encoded into a machine-readable format 303, but it may also be encrypted. For instance, encrypting software may encrypt the traveler information using a particular encryption key such that it may only be decrypted using such key (or a corresponding key). Any encryption technique now known or later discovered may be utilized for encrypting the traveler information. The encrypted traveler information may then be encoded into a machine-readable format 303, such as a standard bar code format, and printed onto baggage tag 302. In this case, if baggage 301 is mishandled, only suitable personnel having the appropriate decryption code may be capable of retrieving the traveler information into a human-readable format. For instance, mass-transit personnel may utilize reader device 305 for reading the machine-readable information 303 from baggage tag 302. Thus, the encrypted information may be read by a suitable reader device 305 that is capable of reading the machine-readable format 303. Once read by such device 305, the traveler information is still encrypted and therefore cannot be understood until decrypted. Thus, decryption software may be utilized on processor-based device 306 to decrypt the encrypted traveler information. This technique may ensure that only authorized personnel having the appropriate decryption software (and decryption key), such as mass-transit personnel, may access the traveler information.

In view of the above, embodiments of the present invention aid in contacting a traveler and/or forwarding mishandled baggage to the traveler in a timely manner. Various embodiments of the present invention enable generation of a baggage tag that includes traveler supplied contact information thereon, at least a portion of which is preferably encoded in a machine-readable format. Thus, such traveler contact information may be retrieved directly from the generated baggage tag to ascertain the most timely and/or appropriate method for reconciliation of mishandled baggage with the traveler (e.g., contacting the traveler regarding the mishandled baggage and/or forwarding the mishandled baggage to the traveler).

While a preferred embodiment is described above for generating a baggage tag having information included thereon for reconciliation of baggage with a traveler, alternative embodiments of the present invention may have other application. Thus, the scope of the present invention is not intended to be limited in application to generating a baggage tag, but may instead encompass generating a tag that comprises user-supplied information, which may be attached to any item to aid in reconciliation of such item with the user based at least in part on the user-supplied information on the tag. For instance, in certain embodiments user information may be generated on a tag, wherein at least a portion of such user information is preferably in machine-readable format, and the tag may be attached to any suitable user item to enable timely reconciliation of such user item with the user.

For example, such tag may be attached to a user's child or pet to enable reconciliation of such child or pet with the user. For instance, kiosk 100 may be implemented at a shopping mall or fun park, as examples, to enable contact information for the user (including the user's itinerary, for example) to be encoded on a tag and such tag may be given/attached to a child. In the event the child becomes separated from the user, the information may be retrieved from the tag such that the child may be timely returned to the user. As another example, such a tag may be associated with a child that is traveling alone (e.g., by airplane, bus, subway, etc.) to enable reconciliation of the child with the user in the event that the child does not timely arrive to the user (e.g., if the child gets on the wrong bus, etc). As a further example, such tag may be attached to a piece of mail to enable timely reconciliation of the mailed item with the user in the event the item is mishandled by the mail carrier. Thus, for instance, kiosk 100 may be implemented at a post office to enable a user to generate a tag having user information encoded thereon (including the user's itinerary, for example), and the tag may be attached to an item being mailed by the user to a particular destination. In this manner, if the mailed item is mishandled such that it does not timely reach the particular destination, the user information may be retrieved from the tag to enable the mailed item to be timely routed to the user (either at the particular destination or at another destination depending on the user's itinerary, for example).

An example of a preferred embodiment has been described above wherein at least a portion of the user information is encoded in a bar code format on the tag. In should be understood that the scope of the present invention is not intended to be limited to such a bar code format, but instead is intended to encompass encoding at least a portion of the user information on a tag in any suitable machine-readable format. For instance, in certain implementations at least a portion of the user information may be encoded electronically into a tag such that the electronically encoded information may be retrieved from the tag by a suitable reader device. For example, a tag may comprise circuitry for storing electronic data, such as a TMU or a smart card, and the tag may be presented by a user to kiosk 100 such that the user information input to kiosk 100 may be programmed as electronic data into the tag's data storage circuitry by kiosk 100. In such an implementation, it may be unnecessary for kiosk 100 to include printer 104. Once the user's information is electronically output to the tag, the tag may be attached to a user's item (e.g., baggage, child, pet, mail, etc.). Thereafter, upon the item to which such a tag is attached being mishandled, the tag may be presented to a suitable reader device operable to retrieve the electronic data stored to such tag for reconciliation of the item with the user. In such implementations, the tag may, for example, be reusable by re-presenting such tag to a kiosk to have the user information stored thereto updated.

What is claimed is:

1. A system comprising:
at least one processor unit;
at least one user input device communicatively coupled to said at least one processor unit;
a display device communicatively coupled to said at least one processor unit;
software code executable by said at least one processor unit to receive as input traveler information that includes contact information for a traveler and further executable to encode at least a portion of said traveler information into a machine-readable format; and
a printer communicatively coupled to said at least one processor unit to print at least the encoded portion of said traveler information on a tag in said machine-readable format.

2. The system of claim 1 wherein said contact information includes temporary contact information.

3. The system of claim 2 wherein said temporary contact information includes information specifying the time period during which such temporary contact information is valid for contacting said traveler.

4. The system of claim 2 wherein said at least a portion of said traveler information encoded into said machine-readable format includes said temporary contact information.

5. The system of claim 1 wherein said contact information includes mobile contact information.

6. The system of claim 5 wherein said mobile contact information includes information selected from the group consisting of a cellular telephone number and a pager number.

7. The system of claim 1 wherein said contact information includes at least one selected from the group consisting of:
home telephone number, work telephone number, cellular telephone number, pager number, and electronic mail address.

8. The system of claim 1 wherein said traveler information further includes a travel itinerary for said traveler.

9. The system of claim 1 wherein said machine-readable format comprises a bar code format.

10. The system of claim 1 wherein said at least a portion of said traveler information encoded into said machine-readable format includes said contact information.

11. The system of claim 1 wherein said software is further executable to encrypt said at least a portion of said traveler information.

12. The system of claim 1 wherein said at least one processor unit, said at least one user input device, said display device, and said printer are included within a kiosk.

13. A kiosk comprising:
means for processing computer-executable instructions;
means for receiving user input, the input receiving means communicatively coupled to the processing means;
means for displaying output to a user, the display means communicatively coupled to the processing means;
software code that is executable by the processing means for receiving as input user information useful for reconciliation of a user item with said user, said user information including contact information for said user; and
software code that is executable by the processing means for encoding at least a portion of said user information into a machine-readable format; and
means for outputting at least the encoded portion of said user information to a tag in said machine-readable format.

14. The kiosk of claim 13 wherein said contact information includes temporary contact information.

15. The kiosk of claim 14 wherein said temporary contact information includes information specifying the time period during which such temporary contact information is valid for contacting said user.

16. The kiosk of claim 14 wherein said at least a portion of said user information encoded into said machine-readable format includes said temporary contact information.

17. The kiosk of claim 13 wherein said user information further includes a travel itinerary for said user.

18. The kiosk of claim 13 wherein said at least a portion of said user information encoded into said machine-readable format includes said contact information.

19. A method for generating a tag that comprises user information that is useful in reconciliation of a user item with a user, said method comprising the steps of:
presenting on a display a user interface to a user that prompts said user to input user information including contact information for said user;
receiving input from said user specifying said user information including contact information for said user;
encoding at least said contact information of said received user information into a machine-readable format, and
outputting at least the encoded contact information to a tag in said machine-readable format.

20. The method of claim 19 wherein said contact information includes temporary contact information, and wherein said temporary contact information includes information specifying the time period during which such temporary contact information is valid for contacting said user.
